(19) United States
(12) Patent Application Publication
(10) Pub. No.: US 2023/0241883 A1
(43) Pub. Date: Aug. 3, 2023

(54) SYSTEM FOR THE MANAGEMENT, CONTROL AND VERIFICATION OF THE PRINTING OPERATIONS MADE BY A PRINTING PLATE

(71) Applicants: Andrea BELLOLI, Cuggiono (MI) (IT); Stefano BELLOLI, Cuggiono (MI) (IT)

(72) Inventors: Andrea BELLOLI, Cuggiono (MI) (IT); Stefano BELLOLI, Cuggiono (MI) (IT)

(21) Appl. No.: 18/007,882

(22) PCT Filed: Jun. 1, 2021
(86) PCT No.: PCT/IB2021/054793

§ 371 Date: Dec. 2, 2022

(30) Foreign Application Priority Data
Jun. 3, 2020 (IT) 102020000013093

(51) Int. Cl. B41F 33/00; B41F 33/16

(52) U.S. Cl. CPC B41F 33/0009; B41F 33/16

(57) ABSTRACT

A system for the management, control and verification of the printing operations carried out by a printing plate includes a printing plate with an associated readable coding element containing significant information of the printing plate, a data acquisition unit for acquiring information from the printing plate, a control and data processing unit that is suitable for receiving the information of the printing plate from the data acquisition unit and for processing the information based on operating parameters of the printing process to provide information relating to print performance, and an information display and presentation unit adapted to carry out a user interface for visualization of the information provided by the control and data processing unit.

The present invention refers to a system for the management, control and verification of the printing operations carried out by a printing plate.

The invention relates in particular, but not exclusively, to flexographic printing procedures.

As is known, flexographic printing is based on the use of a printing plate on which the graphic pattern that is to be reproduced on the surface of the object to be decorated (for example a packaging), which can be of various materials, such as paper, cardboard, plastic film, etc., is made in relief.

The printing plate is usually made starting from a virgin plate, of photopolymer material, on the surface of which a black film (LAM—Laser Ablation Mask) is applied which is engraved by laser according to the graphic pattern to be reproduced.

The virgin plate is then exposed to ultraviolet light, which passes through the graphic pattern engraved by the laser on the LAM, hardening the photopolymer at the graphic pattern itself.

The parts of the not hardened photopolymer, adjacent to the hardened portions corresponding to the graphic pattern to be reproduced, are removed, according to the type of photopolymer used, by means of water-based solutions, by means of solvents, by thermal processes, by laser or by mechanical removal, thus obtaining a plate with relief that corresponds to the image or writings to be printed.

In the case of plates washed with solvent or aqueous solution, after drying in the oven to allow complete evaporation of the solvent or residual drops of the aqueous solution used, the plate is further subjected to ultraviolet radiation (UVA-UVC) to carry out a finishing process and post-exposure of its surface.

After this, the printing plate can be cut to the necessary dimensions and applied, for example by means of double-sided tape, on special cylinders (called sleeves) intended to be mounted on the printing machines, where the relief graphic pattern is inked and the corresponding images and/or writings are printed on the printing support to be decorated.

During the operational life of the printing plate (i.e. the time span during which the plate is used by the printer to reproduce his graphic pattern on the print media to be decorated), many variables may be able to influence the printing performance, for example the printing speed, the greater or lesser ease of assembly and disassembly of the plate on the printing machine, the tendency of the ink to accumulate on the printing surface of the plate and in the spaces between the reliefs of the graphic pattern to be reproduced, which periodically brings about the need to stop the printing machine for the appropriate cleaning operations, a correct or excessive ink consumption, a higher or lower printing pressure, a greater or lesser tendency of the parts and of the plate to wear, which may require a replacement thereof, as well as various other technical drawbacks that can lead to a temporary machine downtime.

All of them contributes to determining what is more generally defined as OEE (Overall Equipment Effectiveness), that is the total efficiency index of a plant or a printing machine.

OEE is an indicator that summarizes some very important concepts from the point of view of manufacturing production, such as the availability, efficiency and rate of quality, productivity and profitability of a plant or a printing machine.

OEE is influenced by various types of inefficiencies that can occur during the production cycle, leading overall to a lower productivity of the plant or the printing machine, for example failures, reductions in printing speed, micro-stops or prolonged stops of the production plant, dead times due to assembly and disassembly of components and various settings, start-up transients, production waste, etc.

It would therefore be desirable for the printer to be able to constantly monitor all the printing operations that are carried out by a specific machine, which is working with a specific printing plate, so as to have under control how and with which efficiency the printing operations are being carried out and possibly taking appropriate action if anomalies are found and, in particular, an anomalous drop in the OEE index.

In this regard, it is necessary to take into account the fact that the level of efficiency is also significantly linked to the characteristics of the printing plate (its shore hardness, the resilience value, the surface tension, the level of maintenance of the surface cleaning, the compatibility with certain inks, the level of abrasion), to the dimensions and type of the graphic pattern (type of dot, e.g. flat, round, etc., dimensions of the minimum dots on the plate, detail of the screens used), to the type of inks used, to the operating temperatures and to the life cycle of the plate itself, where a plate that has been working for a long time, or which is easy to deteriorate, can easily offer lower performance than a new one, or with characteristics suitable for prolonging its life, and negatively influencing the overall productivity.

In the international application WO 2019/192764 A1 a system for the construction of a printing plate is disclosed, where the raw plate contains in itself (for example in an appropriate tag) various identification parameters, as well as information and operating instructions intended to be read by various machines designed to make the plate during the phases for carrying out the graphic pattern, exposure to UV light, washing, drying, finishing, cutting, etc.

However, said system does not solve the problem of the desired optimization, measurement and display of the OEE parameters during the printing operations that are carried out by the printer with the various plates that are available for him on the printing machine.

The general object of the present invention is to overcome the drawbacks mentioned above by providing a system for the management, control, verification and visualization of the printing operations carried out by a given printing plate in a printing plant, which allows to constantly monitor all the operations that are carried out by a given machine, when it is working with a specific printing plate, so as to have under control how and with which efficiency the printing operations are being carried out for the purpose of calculating the OEE index and possibly intervening appropriately if anomalies are found and, in particular, an anomalous drop in said index.

In view of said object, it was thought to create, according to the invention, a system for the management, control, verification and visualization of the printing operations carried out by a printing plate mounted on a printing machine, characterized in that it comprises:
a printing plate having a body with a relief graphic pattern on a surface thereof, destined to be inked to reproduce the relevant writing or image on a printing support, a readable coding element being associated with said plate printing, containing significant information of the printing plate, selected from identification data, technical characteristics and operating parameters of the plate itself;
a unit for acquiring data from the printing plate, suitable for acquiring said significant information of the printing plate;
a control and data processing unit, suitable for receiving said significant information of the printing plate from the data acquisition unit and for processing them on the basis of operating parameters of the printing process to provide information relating to print performance; and
an information display and presentation unit, adapted to carry out a user interface for visualization of said information provided by the control and data processing unit.

To clarify the explanation of the innovative principles of the present invention and the advantages thereof with respect to the prior art, one possible illustrative embodiment applying such principles will be described below, with the aid of the attached drawings.

In the drawings:

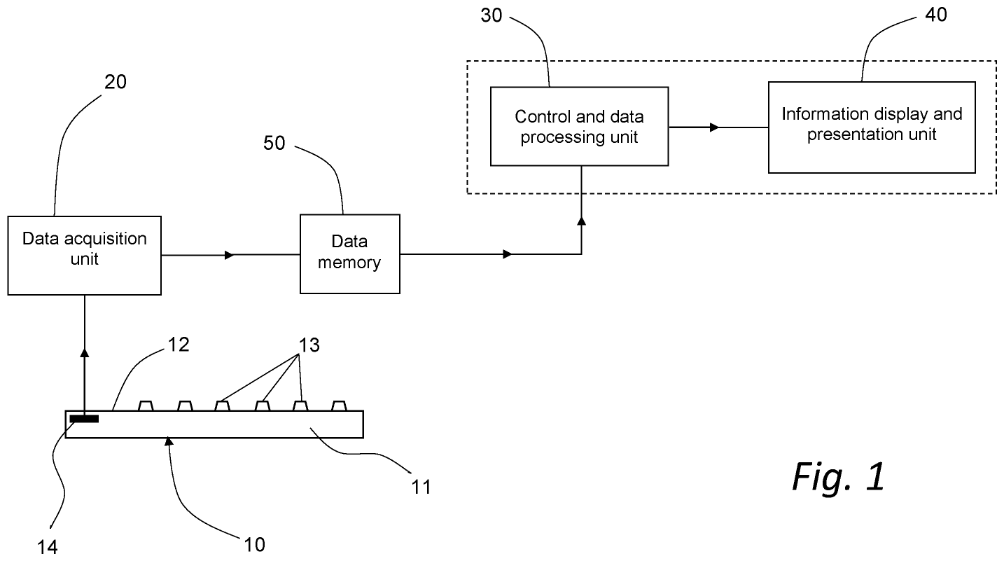

FIG. 1 is a block diagram which schematically represents the system for the management of the printing operations according to the invention.

Conceptually, the system for the management, control and verification of the printing operations according to the invention is based on the cooperation between a printing plate 10, a unit 20 for acquiring data from the printing plate, a control and data processing unit 30 and an information display and presentation unit 40. The printing plate 10 (preferably, but not exclusively, a plate for flexographic printing) is schematically illustrated in FIG. 1 with a body 11 of photopolymer material and, on its surface 12, a relief graphic pattern 13, i.e. the set of the writings and/or images which, once inked, are destined to be printed on the surface of the printing support (for example a packaging), which can be of various materials, such as paper, cardboard, corrugated cardboard, plastic film, etc.

The printing plate 10 is destined to be mounted, according to the prior art, on a printing machine not shown in the diagram of FIG. 1.

A readable coding element 14 is associated with the printing plate 10, containing significant information of the printing plate, selected from identification data, technical characteristics and operating parameters of the plate itself.

Said significant information of the printing plate 10 is destined to be acquired by the unit 20 for acquiring data from the printing plate.

Said readable coding element 14 can be chosen among various systems normally used for the detection of data by means of optical, magnetic reading, transmission by radio frequency, etc. and it can therefore consist, for example, of a bar code, a QR-code, a magnetic strip, microchip, RFID tag, NFC, etc.

The readable coding element 14, depending also on its type, can for example be applied on the surface of the printing plate 10 in a lowered position with respect to the relief graphic pattern, on marginal portions of the plate itself, or incorporated in the photopolymer material with which the body 11 of the plate is made. Other solutions for positioning the readable coding element 14 can of course be designed according to the specific configuration of the printing plate.

For example, the readable coding element could also be included directly in the graphic pattern 13.

Among the significant information of the printing plate 10, the type of plate, where and when it was produced, its shore hardness, the resilience value, the surface tension, the level of maintenance of the surface cleaning, the compatibility with certain inks, the level of abrasion), the dimensions and type of the graphic pattern (type of dot, e.g. flat, round dot, etc., dimensions of the minimum dots on the plate, detail of the screens used), the type of inks used, the operating temperatures, can be advantageously provided for. Depending on the type of readable coding element 14, the unit 20 for acquiring data from the printing plate will be equipped with an optical reader, magnetic reader, radio frequency receiving antenna, etc. Of course, the unit 20 for acquiring data from the printing plate can also comprise two or more of said data acquisition devices, so as to be able to cooperate with printing plates provided with different types of coding elements.

Advantageously, the unit 20 for acquiring data from the printing plate can be incorporated directly into the printing machine on which the plate itself is mounted. However, the data acquisition unit 20 could also consist of a separate device, suitable to be placed in proximity of the printing machine at a distance that is useful for correctly receiving data from the printing plate. Said solution is particularly suitable for using the system for the management, control and verification of the printing operations according to the invention in existing printing plants, without the need to make structural or design modifications to the relative printing machine.

The data acquisition unit 20 is connected to the control and data processing unit 30, to which the aforesaid significant information, acquired by the printing plate, is transmitted, so that it is processed by means of suitable software to provide the requested information relating to the printing operations in progress in the plant with that machine and that specific printing plate.

The information provided by processing the data acquired from the printing plate 10 can of course be of various kinds, depending on the needs of the printer; typically, they can be information relating to printing performance, for example to determine the aforesaid OEE index.

For data processing in order to provide the information requested relating to printing operations, the software of the control and data processing unit 30 can take into account various operating parameters of the printing process, such as for example the maintained print speed, the linear meters of printed printing support, the length of the work shifts and related breaks, and the relevant productivity, the time required for the initial settings of the machine and for the assembly and disassembly of the printing plate and other components, the starting transients, any machine downtime that may occur during the work cycle, the production waste occurred, as well as various other specific factors that the technician in the sector knows well.

The control and data processing unit 30 can be integrated in the printing machine, or constituted by a separate device, for example a PC, so as to be accessible to operators present in a centralized control room of the printing machines.

The software used by the control and data processing unit 30 could advantageously comprise an App present on a mobile device (typically a smartphone), so as to be accessible and controllable even remotely.

Between the data acquisition unit 20 and the control and data processing unit 30 there may advantageously be present a data memory 50, wherein data relating to printing plates previously used in the printing machine and to the respective operations carried out are stored, (basically, the “history” of said plates), updating such data every time a certain printing plate is used, so as to facilitate and implement the data processing capabilities for the production of the information required by the operator.

The data memory 50 can also be advantageously integrated in the printing machine.

The data memory 50 is also particularly useful for allowing to know, at any time, all the data relating to the operating life of the printing plate. For example, the software or the App used will thus be able to “dialogue” with a specific printing plate, allowing the printer to know at any time the age of the plate, which graphic pattern is present in it, how many print processes it has made and on which products, the minimum, maximum and average print speed, how many machine downtimes occurred, which profitability allowed to achieve in the plant, etc.

Finally, an information display and presentation unit 40 is associated with the control and data processing unit 30, capable of providing an interface (possibly of an interactive type) in which the operator can read and see the result of the processing of the data that led to the generation of the information requested, relating to the progress of the printing process and its performance.

The information display and presentation unit 40 can typically be a monitor, or in any case a screen exposed to the operator's view. Advantageously, the information display and presentation unit 40 can be integrated in the same device together with the control and data processing unit 30 (as shown schematically with the dashed line in FIG. 1), in particular when the control and data processing unit 30 consists of a PC, or when it is an integral part of the printing machine.

At this point it is clear how the system for the management, control and verification of the printing operations according to the invention allows to achieve the set objects, constantly monitoring all the operations that are carried out by a given machine, when it is working with a specific printing plate, so as to have a clear picture of the printing process and, in particular, of the performance of the plant and of the OEE efficiency index in carrying out the operations in progress.

Clearly, the above description of an embodiment applying the innovative principles of the present invention is given by way of an illustrative example of such innovative principles and must not, therefore, be taken to limit the scope of the patent claimed herein.

For example, the information provided by the control and data processing unit 30 could be viewable by the operator (also through the associated App) through a wearable electronic device, such as for example the so-called “smart glasses” used for augmented reality display.

1. A system for management, control, verification, and visualization of printing operations carried out by a printing plate mounted on a printing machine, the system comprising:
a printing plate having a body with a relief graphic pattern on a surface thereof, destined to be inked to reproduce relevant writing or image on a printing support, wherein a readable coding element is associated with said printing plate and contains at least significant information of the printing plate selected from the group consisting of identification data, technical characteristics and operating parameters of the printing plate;
a data acquisition unit that acquires data from the printing plate and is suitable for acquiring said significant information of the printing plate;
a control and data processing unit that is suitable for receiving said significant information of the printing plate from the data acquisition unit and for processing the information based on operating parameters of a printing process to provide information relating to print performance; and
an information display and presentation unit that is adapted to carry out a user interface for visualization of information provided by the control and data processing unit;
wherein the information provided by the control and data processing unit is directed to determination of an Overall Equipment Effectiveness (OEE) index based on the operating parameters of the printing process which include a print speed maintained during the process, a length of the printing support, a length of work shifts and related breaks, time required for initial settings of the printing machine and for assembly and disassembly of the printing plate and other components, starting transients, machine downtimes that occurred during work cycle, and production waste occurred.

2. The system according to claim 1, further comprising:
between the data acquisition unit and the control and data processing unit, a data memory, which stores data relating to printing plates previously used in the printing machine and to the respective operations carried out and updates the data every time a certain printing plate is used.

3. The system according to claim 1, wherein said readable coding element is an optical reading element, a magnetic reading element, or a radio frequency transmission element.

4. The system according to claim 1, wherein the data acquisition unit comprises, depending on the type of the readable coding element, at least one data acquisition device selected from the group consisting of an optical reading data acquisition device, a magnetic reading data acquisition device, and a radio frequency receiving antenna.

5. The system according to claim 1, wherein the data acquisition unit is integrated in the printing machine.

6. The system according to claim 1, wherein the control and data processing unit is integrated in the printing machine.

7. The system according to claim 1, wherein the information display and presentation unit is a part of the same device as the control and data processing unit.

8. (canceled)
